(19) United States
(12) Patent Application Publication
(10) Pub. No.: US 2025/0084229 A1
(43) Pub. Date: Mar. 13, 2025

(54) Aramid Aerogel and A Preparation Method thereof

(71) Applicant: Microvast Advanced Membranes Inc., Lake Mary, FL (US)

(72) Inventors: Haipeng ZHANG, Huzhou (CN); Jinbo HE, Huzhou (CN); Qingjin SUN, Huzhou (CN); Wenjuan Liu MATTIS, Stafford, TX (US)

(21) Appl. No.: 18/244,322

(22) Filed: Sep. 11, 2023

(51) Int. Cl. C08J 9/28

(52) U.S. Cl. CPC C08J 9/28; C08J 2205/026; C08J 2205/042; C08J 2377/06

(57) ABSTRACT

Provided in the present disclosure are an aramid aerogel and a preparation method thereof. The aramid aerogel is a porous material, and the porosity of the aramid aerogel is 65-99%. By means of the preparation method in the present disclosure, an aramid material having good high heat resistance may be prepared into the aramid aerogel, such that the aramid aerogel is suitable for industrial production. An application range of the aramid aerogel is expanded by owning the aramid aerogel with the above porosity. In addition, the aramid aerogel has good structure and mechanical properties and excellent thermal insulation performance, and in particular, has a very good application prospect in the field of high temperature thermal insulation.

### TECHNICAL FIELD

The disclosure relates to the technical field of aerogel, and specifically, to an aramid aerogel and a preparation method thereof.

### BACKGROUND

Aerogel has the characteristics of being high in specific surface area, high in porosity, low in density, and high in absorbability, etc. Therefore, the aerogel has wide application prospects in the fields such as energy conservation and environmental protection, biomedicine, aerospace, and building insulation materials. Since the first aerogel was prepared by the professor Kistler in 1931, the aerogel has become a hot material for scholars to study nowadays, and various types of inorganic aerogel, organic aerogel, and inorganic/organic composite aerogel have been successfully developed. However, methods for preparing aramid aerogel suitable for industrialization have not been publicly reported at present.

### SUMMARY

The present disclosure is mainly intended to provide an aramid aerogel and a preparation method thereof.

In order to implement the above objective, an aspect of the present disclosure provides an aramid aerogel, the aramid aerogel is a porous material, and the porosity of the aramid aerogel is 65-99%.

As an implementation, a specific surface area of the aramid aerogel is 50-1000 m²/g; and/or a pore volume of the aramid aerogel is 0.05-1.5 cm³/g.

As an implementation, an average pore diameter of pores of the aramid aerogel is 1-50 nm; and/or the density of the aramid aerogel is 1-500 mg/cm³.

Another aspect of the present disclosure provides a method for preparing the aramid aerogel, the preparation method includes: step S1, in an oxygen-free atmosphere, performing a complex reaction on raw materials including aramid slurry and ferrous halide, so as to obtain a complex precipitate; step S2, performing a gelation reaction on the complex precipitate and a gelation reagent, so as to obtain gel; step S3, performing solvent displacement treatment on the gel, so as to obtain an aramid precipitate; and step S4, drying the aramid precipitate, so as to obtain the aramid aerogel.

As an implementation, in the step S1, a mass ratio of aramid in the aramid slurry to the ferrous halide is 0.032-0.8:1.

As an implementation, the aramid in the aramid slurry is any one or more of poly(p-phenylene terephthamide), polymetaphenylene isophthalamide, poly(p-benzamide), and polyphenylsulfone terephthalamide.

As an implementation, in the step S1, the temperature of the complex reaction is 5-60° C.; and/or time for the complex reaction is 0.3-33 h.

As an implementation, the aramid slurry comprises a first solvent; and the first solvent is any one or more of dimethyl sulfoxide, N, N-dimethylformamide, N, N-dimethylacetamide, N, N-dimethylhexanamide, N-methylpyrrolidone, and triethyl phosphate.

As an implementation, the solid content of the aramid slurry is 1-10%, and/or the pH value of the aramid slurry is 2-7.

As an implementation, in the step S1, the ferrous halide is a ferrous halide powder or a ferrous halide solution; the ferrous halide is selected from any one or more of ferrous chloride tetrahydrate, anhydrous ferrous chloride, ferrous bromide hydrate, and anhydrous ferrous bromide; and the ferrous halide solution includes the ferrous halide and a second solvent.

As an implementation, the second solvent is any one or more of water, methanol, ethanol, and acetic acid.

As an implementation, a mass ratio of the ferrous halide to the second solvent is 10-20:5-10.

As an implementation, in the step S2, the temperature of the gelation reaction is 5-60° C.; and/or time for the gelation reaction is 3-30 h.

As an implementation, in the step S2, the gelation reagent is selected from any one or more of water, an aqueous solution containing 20 wt. %-50 wt. % of N, N-dimethylacetamide, hydrochloric acid, sulfuric acid, ethanol, ethylene glycol, glycerol, acetone, tetrahydrofuran, chloroform, dichloromethane, glacial acetic acid, and nitric acid.

As an implementation, in the step S3, a number of times for solvent displacement treatment is 3-10, and/or time for solvent displacement treatment is 2-4 h/time.

As an implementation, in the step S4, drying treatment includes performing a vacuum freeze-drying process and/or a vacuum drying process on the aramid precipitate, the vacuum freeze-drying process includes: holding the aramid precipitate at −40° C. to −20° C. for 4-10 h, and then under a vacuum condition, successively holding the aramid precipitate at −20° C. to −10° C. for 4-10 h, at −10° C. to 0° C. for 4-10 h, and at 0° C. to 10° C. for 4-10 h.

As an implementation, the vacuum drying process includes: the aramid precipitate or the aramid precipitate which is obtained after vacuum drying is held at 100° C. to 150° C. for 6-10 h.

As an implementation, the preparation method further includes a process of preparing the aramid slurry, the preparation process includes: performing an amidation reaction on raw materials including aromatic diacyl chloride, aromatic diamine, and a third solvent, so as to obtain an amidation product; neutralizing the amidation product by using an alkaline reagent, so as to obtain a neutralized product; diluting the neutralized product by using a fourth solvent, so as to obtain the aramid slurry; or dissolving aramid into the fourth solvent, so as to obtain the aramid slurry.

As an implementation, a mass ratio of the aromatic diacyl chloride to the third solvent is 10-30:45-135, and/or a mass ratio of the aromatic diamine to the third solvent is 5-15:45-135; and/or the third solvent and the fourth solvent are respectively independently selected from any one or more of dimethyl sulfoxide, N,N-dimethylformamide, N, N-dimethylacetamide, N, N-dimethylhexanamide, N-methylpyrrolidone, and triethyl phosphate.

As an implementation, the solid content of the neutralized product is 10-30%, and/or the using amount of the alkaline reagent is 1-5% of a total mass of the amidation product.

By means of the preparation method in the present disclosure, an aramid material having good high heat resistance may be prepared into the aramid aerogel, such that the aramid aerogel is suitable for industrial production. The prepared aramid aerogel has good structure and mechanical properties and excellent thermal insulation performance, and in particular, has a very good application prospect in the field of high temperature thermal insulation.

### BRIEF DESCRIPTION OF THE DRAWINGS

The drawings, which form a part of this disclosure, are used to provide a further understanding of the present disclosure, the exemplary embodiments of the present disclosure and the description thereof are used to explain the present disclosure, but do not constitute improper limitations to the present disclosure. In the drawings:

FIG. 1 shows a Scanning Electron Microscope (SEM) diagram of an aramid aerogel according to Embodiment 1 of the present disclosure.

### DETAILED DESCRIPTION OF THE EMBODIMENTS

It is to be noted that the embodiments in this disclosure and the features in the embodiments may be combined with one another without conflict. The disclosure will be described below in detail with reference to the drawings and the embodiments.

The present disclosure provides an aramid aerogel and a preparation method thereof.

A typical implementation of the present disclosure provides an aramid aerogel, wherein

the aramid aerogel is a porous material, and the porosity of the aramid aerogel is 65-99%.

An application range of the aramid aerogel is expanded by owning the aramid aerogel with the above porosity. In addition, the aramid aerogel has good structure and mechanical properties and excellent thermal insulation performance, and in particular, has a very good application prospect in the field of high temperature thermal insulation, and thus suitable for industrial production. In addition, the porosity of the aramid aerogel may be 70-90%, or 75-85%, or 80-92%.

In some embodiments of the present disclosure, a specific surface area of the aramid aerogel is 50-1000 m²/g; and/or a pore volume of the aramid aerogel is 0.05-1.5 cm³/g.

The aramid aerogel has a large specific surface area, wherein, the specific surface area of the aramid aerogel may be 80-900 m²/g, or 120-700 m²/g, or 240-600 m²/g, or 360-500 m²/g, or 400-650 m²/g. The pore volume of the aramid aerogel is within the above range, wherein, the pore volume of the aramid aerogel may be 0.08-1.2 cm³/g, or 0.1-1 cm³/g, or 0.3-0.7 cm³/g, or 0.5-0.9 cm³/g. There are numerous pores in the aramid aerogel which has the specific surface area and the pore volume, such that a heat conductivity coefficient of the aramid aerogel is greatly reduced, and thermal insulation performance of the aramid aerogel is improved.

In some embodiments of the present disclosure, an average pore diameter of pores of the aramid aerogel is 1-50 nm; and/or the density of the aramid aerogel is 1-500 mg/cm³.

The average pore diameter of the pores of the aramid aerogel may be 6-40 nm, or 10-30 nm, or 15-40 nm, or 20-40 nm. The density of the aramid aerogel is within the above range, giving the aramid aerogel the advantage of being light-weight, wherein, the density of the aramid aerogel may be 20-400 mg/cm³, or 40-300 mg/cm³, or 60-200 mg/cm³, or 80-100 mg/cm³. Aerogel is a non-vacuum thermal insulation material (porous material), which mainly plays a role by means of inhibiting heat conduction. A combination of low density and small pores makes the aerogel have a relatively-low heat conductivity. Further, aramid itself has good heat-resistant properties, such that the aramid aerogel materials may have great application prospects in the field of thermal insulation.

Another typical implementation of the present disclosure provides a method for preparing the aramid aerogel, the preparation method includes: step S1, in an oxygen-free atmosphere, performing a complex reaction on raw materials including aramid slurry and ferrous halide, so as to obtain a complex precipitate; step S2, performing a gelation reaction on the complex precipitate and a gelation reagent, so as to obtain gel; step S3, performing solvent displacement treatment on the gel, so as to obtain an aramid precipitate; and step S4, drying the aramid precipitate, so as to obtain the aramid aerogel.

The aramid itself has good heat-resistant properties, the preparation method uses the aramid slurry as a wet raw material and a ferrous halide solution as a complexing agent, an acting force is generated among aramid molecules by using a coordination complex effect of ferrous ions on the aramid molecules, so as to form the complex precipitate including a porous three-dimensional structure, such that a pore structure of the final aramid aerogel is greatly fundamentally enriched, the average pore diameter of the pores of the aramid aerogel is reduced, and the porosity of the aramid aerogel is increased, the aramid aerogel has good structure and mechanical properties, and heat resistance, such that the application range of the aramid aerogel is widened, and is more suitable for being used in the field of thermal insulation. Wherein the three-dimensional structure of the complex precipitate is immobilized by the gelation reaction, such that the structure of the obtained aramid aerogel is prevented from collapsing. Solvents and moisture left in the aramid aerogel are further removed through solvent displacement treatment and drying treatment, such that the stability of the aramid aerogel is improved. In addition, compared with traditional preparation methods, the preparation method is simple, efficient, low in energy consumption, and low in cost, such that large-scale mass production may be realized, thereby enlarging the application range of the aramid aerogel.

In some embodiments of the present disclosure, in the step S1, the complex reaction includes at 5-60° C., a process of first stirring and then standing, a stirring rate is 100-800 r/min, stirring time is 0.3-3 h, and standing time is 4-30 h.

Under conditions of the above stirring rate and time, the aramid slurry and the raw materials of the ferrous halide are mixed more uniformly, such that more of complex precipitates are precipitated for the above standing time.

In some embodiments of the present disclosure, in S1, a mass ratio of aramid in the aramid slurry to the ferrous halide is 0.032-0.8:1, or 0.08-0.32:1, facilitating the control of an actual reaction concentration of the aramid slurry and the ferrous halide, such that the efficiency and effect of the complex reaction are improved to the greatest extent, so as to cause the obtained complex precipitate to have higher porosity.

In some embodiments of the present disclosure, the aramid in the aramid slurry is any one or more of poly(p-phenylene terephthamide), polymetaphenylene isophthalamide, poly(p-benzamide), and polyphenylsulfone terephthalamide. Therefore, the universality of the aramid slurry is improved, thereby further enriching types of the aramid aerogel obtained by the above method.

In some embodiments of the present disclosure, in the step S1, the temperature of the complex reaction is 5-60° C.; and/or the time for the complex reaction is 0.3-33 h. Therefore, the efficiency and effect of the complex reaction are improved.

In some embodiments of the present disclosure, the aramid slurry comprises a first solvent; and the first solvent is any one or more of dimethyl sulfoxide, N, N-dimethylformamide, N, N-dimethylacetamide, N,N-dimethylhexanamide, N-methylpyrrolidone, and triethyl phosphate.

The first solvent is conductive to improving the mixing uniformity of the aramid slurry and the raw materials of the ferrous halide, thereby improving the efficiency and effect of the complex reaction.

In some embodiments of the present disclosure, in the step S1, the solid content of the aramid slurry is 1-10%, and/or the pH value of the aramid slurry is 2-7.

The solid content of the aramid slurry aids in its complex reaction with the ferrous ions in the ferrous halide solution under an appropriate concentration. The aramid slurry within the above pH value range is conductive to improving a synergistic complexing effect between the ferrous ions and the aramid molecules, and side reactions such as ferrous ion precipitation are minimized, Wherein the pH value of the aramid slurry may also be 4-5; and when the pH value is 4-5, the complex reaction is better in effect.

In some embodiments of the present disclosure, in the step S1, the ferrous halide is ferrous halide powder or a ferrous halide solution; and the ferrous halide solution includes the ferrous halide and a second solvent.

In some embodiments of the present disclosure, the ferrous halide is selected from any one or more of ferrous chloride tetrahydrate, anhydrous ferrous chloride, ferrous bromide hydrate, and anhydrous ferrous bromide. The ferrous halide ionizes freely moving ferrous ions in the second solvent, so as to be subjected to the complex reaction with the aramid molecules, definitely, a person skilled in the art may also select other ferrous ion solutions to perform the complex reaction with the aramid molecules, details are not described herein again.

In some embodiments of the present disclosure, the second solvent is any one or more of water, methanol, ethanol, and acetic acid.

The second solvent is more conductive to improving a dispersion effect of the ferrous halide and the aramid molecules in the second solvent, such that the efficiency and effect of the complex reaction are improved.

In some embodiments of the present disclosure, a mass ratio of the ferrous halide to the second solvent is 10-20:5-10.

The mass ratio of the ferrous halide to the second solvent makes the ferrous ions in the ferrous halide solution have an appropriate concentration, thereby improving a complex effect between the ferrous halide and the aramid molecules.

In some embodiments of the present disclosure, in the step S2, the temperature of the gelation reaction is 5-60° C.; and/or the time for the gelation reaction is 3-30 h.

By controlling the temperature and time of the gelation reaction, the efficiency and effect of the gelation reaction are improved.

In some embodiments of the present disclosure, in the step S2, the gelation reagent is selected from any one or more of water, an aqueous solution containing 20 wt. %-50 wt. % of N, N-dimethylacetamide, hydrochloric acid, sulfuric acid, ethanol, ethylene glycol, glycerol, acetone, tetrahydrofuran, chloroform, dichloromethane, glacial acetic acid, and nitric acid. Therefore, the efficiency and effect of a gelation process are improved.

In some embodiments of the present disclosure, in the step S3, the number of times for solvent displacement treatment is 3-10, and/or the time for solvent displacement treatment is 2-4 h/time.

Solvent displacement is intended to remove the solvents (the solvents introduced by the aramid slurry) left in the aramid aerogel, so as to conveniently perform the subsequent step of drying treatment. The removal efficiency and effect of the solvents left in the aramid aerogel are improved by controlling the number of times of solvent displacement treatment and the time for each solvent displacement treatment to be within the above range.

In some embodiments of the present disclosure, in the step S4, drying treatment includes successively performing vacuum freeze-drying and/or vacuum drying processes on the aramid precipitate. The vacuum freeze-drying process includes: holding the aramid precipitate at −40° C. to −20° C. for 4-10 h, and then under a vacuum condition, successively holding the aramid precipitate at −20° C. to −10° C. for 4-10 h, at −10° C. to 0° C. for 4-10 h, and at 0° C. to 10° C. for 4-10 h.

Excess moisture in the aerogel is removed through vacuum freeze-drying treatment. A removal principle is to sublimate moisture and remove the moisture as solid water, so as to reduce the influence on the three-dimensional structure of the aerogel, the moisture in the aerogel is completely removed during the vacuum freeze-drying process with step-by-step temperature increase.

In some embodiments of the present disclosure, the vacuum drying process includes: the aramid precipitate or the aramid precipitate which is obtained after vacuum drying is held at 100-150° C. for 6-10 h.

The solvents (the solvents introduced by the aramid slurry) left in the aerogel are further removed through vacuum drying treatment; and a removal principle is to vaporize the solvents and remove the solvents as gases.

Through the drying treatment process, the moisture and other left solvents in the aerogel are removed more completely, such that the storage stability and performance stability of the aramid aerogel are ensured.

In some embodiments of the present disclosure, the preparation method further includes a process of preparing the aramid slurry. The preparation process includes: performing an amidation reaction on raw materials including aromatic diacyl chloride, aromatic diamine, and a third solvent, so as to obtain an amidation product; neutralizing the amidation product by using an alkaline reagent, so as to obtain a neutralized product; in this way, the aramid slurry is more suitable for being subjected to coordination with the ferrous ions, and side reactions such as ferrous ion precipitation are minimized. The neutralized product is diluted by using the fourth solvent, so as to obtain the aramid slurry, or the aramid is dissolved in the fourth solvent, so as to obtain the aramid slurry, such that the viscosity and concentration of the aramid slurry are more suitable for the complex reaction with the ferrous ions. In addition, the temperature of the amidation reaction is −40° C. to 40° C., or −20° C. to 0° C., the amidation reaction is performed under the condition of the stirring rate being 100-800 r/min, such that the efficiency and effect of the amidation reaction are controlled more conveniently.

In some embodiments of the present disclosure, a mass ratio of the aromatic diacyl chloride to the third solvent is 10-30:45-135, and/or a mass ratio of the aromatic diamine to the third solvent is 5-15:45-135, such that the aromatic diacyl chloride and the aromatic diamine are reacted more thoroughly. As an implementation, a substituent position relationship between chlorine substituents on the aromatic diacyl chloride and a substituent position relationship between amino groups on the aromatic diamine are the same. For example, when two acyl chloride groups are in a meta-position, two amino groups are also in the meta-position, such that the obtained aramid slurry reacts better in the subsequent complex reaction, thereby causing the porosity of the obtained aramid aerogel to be higher; and/or the third solvent and the fourth solvent are respectively independently selected from any one or more of dimethyl sulfoxide, N, N-dimethylformamide, N, N-dimethylacetamide, N, N-dimethylhexanamide, N-methylpyrrolidone, and triethyl phosphate, facilitating dissolution and uniform mixing of the aromatic diacyl chloride and the aromatic diamine, thereby improving reaction efficiency.

In some embodiments of the present disclosure, the solid content of the neutralized product is 10-30%, and/or the using amount of the alkaline reagent is 1-5% of a total mass of the amidation product. The alkaline reagent is selected from any one or more of potassium hydroxide, sodium hydroxide, calcium hydroxide, sodium tert-butoxide, potassium tert-butoxide, potassium hexamethyldisilazide, sodium hexamethyldisilazide, potassium ethoxy, triethylamine, tetramethylethylene diamine, sodium hydride, and potassium hydride, therefore, the pH value of the amidation product is adjusted to an appropriate range, and the amidation product is more easily reacted with the ferrous halide.

The present disclosure is further described in detail below with reference to specific embodiments, and the embodiments cannot be construed as limiting the scope of protection claimed in the present disclosure.

### Embodiment 1

At step S1, 20 g of isophthaloyl chloride and 10 g of m-phenylenediamine were dissolved into 90 g of N, N-dimethylacetamide; the mixture was stirred at 400 r/min at −20° C., and reacted to synthesize aramid slurry 1; and when the viscosity of the aramid slurry 1 was 200-300 cps, 1.20 g of calcium hydroxide was added to adjust the pH value of the aramid slurry 1, with the pH value being 5. The concentration of aramid in the aramid slurry 1 was 15 wt %; and the aramid slurry 1 was diluted by using 360 g of a N, N-dimethylacetamide solution, so as to prepare aramid slurry 2 with the concentration being 3.75 wt %.

At step S2, 32 g of the aramid slurry 2 was taken to place into a closed three-necked flask; dry nitrogen was blown into the three-necked flask for 1 h, so as to ensure that there is a dry and oxygen-free environment in the three-necked flask; 6 g of ferrous chloride tetrahydrate powder was taken and dissolved into 4 g of water; then an aqueous solution containing ferrous chloride tetrahydrate was added into the aramid slurry 2, stirred for 1 h at the speed of 400 r/min, so as to cause the ferrous chloride tetrahydrate to be fully dissolved in the aramid slurry 2, and then allowed to stand for 5 h, so as to undergo a complex reaction between ferrous chloride molecules and aramid molecules; and chemical crosslinking was performed between the ferrous chloride molecules and the aramid molecules, and a blocky complex precipitate 1 was formed after reaction.

At step S3, the complex precipitate 1 was taken and added into water, so as to perform a gelation reaction process for 6 h; then solvent displacement treatment was performed on the mixture; the water was changed every 4 h, with a total of 4 times, so as to obtain an aramid precipitate 1.

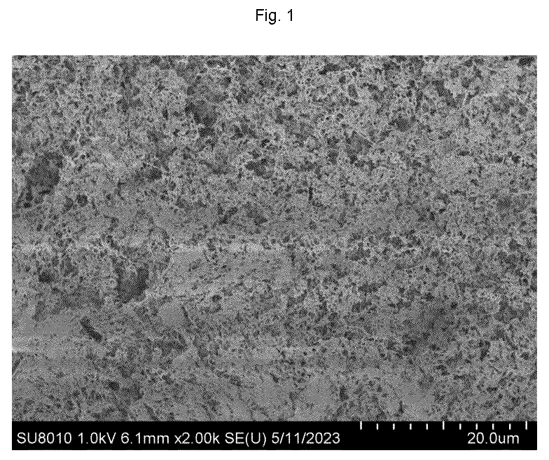

At step S4, the aramid precipitate 1 was taken; vacuum freeze-drying was performed; and then vacuum drying was performed. The vacuum freeze-drying process included: placing a aramid precipitate 1 sample into a device, continuously holding a temperature at −20° C. for 4 h, then performing vacuuming until a vacuum degree was 0.5 Pa, holding the vacuum degree, rising the temperature to −10° C., and holding the temperature for 4 h; then rising the temperature to 0° C., and holding the temperature for 4 h; then rising the temperature to 10° C., and holding the temperature for 4 h; and taking the mixture out after the reaction ended, so as to obtain a vacuum freeze-dried aramid precipitate. The vacuum drying process included: vacuuming an oven until the vacuum degree was 0.5 Pa, setting the temperature of the oven to 100° C., and drying the vacuum freeze-dried aramid precipitate for 6 h; and taking the obtained product aramid aerogel after the reaction ended. FIG. 1 is a Scanning Electron Microscope (SEM) diagram of the aramid aerogel obtained in Embodiment 1. Table 1 showed test results of the specific surface area and average pore diameter of the aramid aerogel obtained in Embodiment 1. Table 1 indicated that the specific surface area of the aramid aerogel product obtained in Embodiment 1 reached an extremely high 634 m²/g, and the average pore diameter was 6.088 nm.

A heating table was heated to 560° C. and maintained at a constant temperature; then the prepared aramid aerogel was filled into glass fiber, and then placed on the heating table; and a temperature sensor was used to test a temperature on the surface of the sample, and a temperature t on the surface of the sample after being heated for 10 min was recorded, thermal insulation coefficient=(560−t)/560*100%. By means of the method, the thermal insulation coefficient was tested to be 62.5% when the aramid aerogel was not filled into the glass fiber, and the thermal insulation coefficient was 83% after filling.

### Embodiment 2

The difference between this embodiment and Embodiment 1 lied in that, at step S2, the aqueous solution containing the ferrous chloride tetrahydrate was added into the aramid slurry 2, and stirred for 1 h at the speed of 100 r/min, so as to obtain the complex precipitate 1, and the aramid aerogel was obtained finally.

### Embodiment 3

The difference between this embodiment and Embodiment 1 lied in that, at step S2, the aqueous solution containing the ferrous chloride tetrahydrate was added into the aramid slurry 2, and stirred for 1 h at the speed of 800 r/min, so as to obtain the complex precipitate 1, and the aramid aerogel was obtained finally.

### Embodiment 4

The difference between this embodiment and Embodiment 1 lied in that, at step S2, the aqueous solution containing the ferrous chloride tetrahydrate was added into the aramid slurry 2, and stirred for 1 h at the speed of 50 r/min, so as to obtain the complex precipitate 1, and the aramid aerogel was obtained finally.

### Embodiment 5

The difference between this embodiment and Embodiment 1 lied in that, at step S2, the aqueous solution containing the ferrous chloride tetrahydrate was added into the aramid slurry 2, and stirred for 0.3 h at the speed of 400 r/min, so as to obtain the complex precipitate 1, and the aramid aerogel was obtained finally.

### Embodiment 6

The difference between this embodiment and Embodiment 1 lied in that, at step S2, the aqueous solution containing the ferrous chloride tetrahydrate was added into the aramid slurry 2, and stirred for 3 h at the speed of 400 r/min, so as to obtain the complex precipitate 1, and the aramid aerogel was obtained finally.

### Embodiment 7

The difference between this embodiment and Embodiment 1 lied in that, at step S2, the aqueous solution containing the ferrous chloride tetrahydrate was added into the aramid slurry 2, and stirred for 10 min at the speed of 400 r/min, so as to obtain the complex precipitate 1, and the aramid aerogel was obtained finally.

### Embodiment 8

The difference between this embodiment and Embodiment 1 lied in that, at step S2, the ferrous chloride tetrahydrate was fully dissolved into the aramid slurry 2, and then allowed to stand for 30 h, so as to obtain the complex precipitate 1, and the aramid aerogel was obtained finally.

### Embodiment 9

The difference between this embodiment and Embodiment 1 lied in that, at step S2, the ferrous chloride tetrahydrate was fully dissolved into the aramid slurry 2, and then allowed to stand for 3 h, so as to obtain the complex precipitate 1, and the aramid aerogel was obtained finally.

### Embodiment 10

The difference between this embodiment and Embodiment 1 lied in that, at step S1, 1.08 g of the calcium hydroxide was added to adjust the pH value of the aramid slurry 1, with the pH value being 4; and the aramid aerogel was obtained finally.

### Embodiment 11

The difference between this embodiment and Embodiment 1 lied in that, at step S1, 0.67 g of the calcium hydroxide was added to adjust the pH value of the aramid slurry 1, with the pH value being 3; and the aramid aerogel was obtained finally.

### Embodiment 12

The difference between this embodiment and Embodiment 1 lied in that, at step S1, 1.38 g of the calcium hydroxide was added to adjust the pH value of the aramid slurry 1, with the pH value being 6; and the aramid aerogel was obtained finally.

### Embodiment 13

The difference between this embodiment and Embodiment 1 lied in that, at step S1, the aramid slurry 1 was diluted by using 1680 g of the N, N-dimethylacetamide solution, so as to prepare the aramid slurry 2 with the concentration being 1%; and the aramid aerogel was obtained finally.

### Embodiment 14

The difference between this embodiment and Embodiment 1 lied in that, at step S1, the aramid slurry 1 was diluted by using 60 g of the N, N-dimethylacetamide solution, so as to prepare the aramid slurry 2 with the concentration being 10%; and the aramid aerogel was obtained finally.

### Embodiment 15

The difference between this embodiment and Embodiment 1 lied in that, at step S1, the aramid slurry 1 was not diluted; the aramid slurry 1 was directly used as the aramid slurry 2, and the concentration of the aramid slurry 2 was 15 wt %; and the aramid aerogel was obtained finally.

### Embodiment 16

The difference between this embodiment and Embodiment 1 lied in that, at step S2, a ferrous halide solution was anhydrous ferrous bromide, and the complex precipitate 1 was obtained; and the aramid aerogel was obtained finally.

### Embodiment 17

The difference between this embodiment and Embodiment 1 lied in that, at step S2, the mass of aramid slurry was unchanged; the addition of the ferrous chloride tetrahydrate powder was 15 g; a mass ratio of aramid molecules in the aramid slurry to the ferrous chloride tetrahydrate was 0.08:1; the complex precipitate 1 was obtained; and the aramid aerogel was obtained finally.

### Embodiment 18

The difference between this embodiment and Embodiment 1 lied in that, at step S2, the mass of aramid slurry was unchanged; the addition of the ferrous chloride tetrahydrate powder was 3.75 g; a mass ratio of aramid molecules in the aramid slurry to the ferrous chloride tetrahydrate was 0.32:1; the complex precipitate 1 was obtained; and the aramid aerogel was obtained finally.

### Embodiment 19

The difference between this embodiment and Embodiment 1 lied in that, at step S2, the mass of aramid slurry was unchanged; the addition of the ferrous chloride tetrahydrate powder was 0.3 g; a mass ratio of aramid molecules in the aramid slurry to the ferrous chloride tetrahydrate was 4:1; the complex precipitate 1 was obtained; and the aramid aerogel was obtained finally.

### Embodiment 20

The difference between this embodiment and Embodiment 1 lied in that, at step S3, the complex precipitate 1 was taken and added into glycerol, so as to perform the gelation reaction process for 30 h; then solvent displacement treatment was performed on the mixture; the water was changed every 4 h, with a total of 4 times, so as to obtain the aramid precipitate 1; and the aramid aerogel was obtained finally.

### Embodiment 21

The difference between this embodiment and Embodiment 1 lied in that, at step S3, the complex precipitate 1 was taken and added into dichloromethane, so as to perform the gelation reaction process for 6 h; then solvent displacement treatment was performed on the mixture; the water was changed every 4 h, with a total of 4 times, so as to obtain the aramid precipitate 1; and the aramid aerogel was obtained finally.

### Embodiment 22

The difference between this embodiment and Embodiment 1 lied in that, at step S3, the complex precipitate 1 was taken and added into dichloromethane, so as to perform the gelation reaction process for 6 h; then solvent displacement treatment was performed on the mixture; the water was changed every 2 h, with a total of 10 times, so as to obtain the aramid precipitate 1; and the aramid aerogel was obtained finally.

### Embodiment 23

The difference between this embodiment and Embodiment 1 lied in that, at step S1, 20 g of isophthaloyl chloride and 10 g of m-phenylenediamine were dissolved into 90 g of N-methylpyrrolidone; the mixture was stirred at 800 r/min at −20° C., and reacted to synthesize the aramid slurry 1; when the viscosity of the aramid slurry 1 was 200-300 cps, 1.2 g of potassium tert-butoxide was added to adjust the pH value of the aramid slurry 1; the concentration of aramid in the aramid slurry 1 was 15%; the aramid slurry 1 was diluted by using 90 g of the N-methylpyrrolidone, so as to prepare the aramid slurry 2 with the concentration being 3.75%, with the pH value being 5; and the aramid aerogel was obtained finally.

### Embodiment 24

The difference between this embodiment and Embodiment 1 lied in that, at step S1, 1.2 g of a dry aramid material and 36 g of DMAC were taken to place into a closed three-necked flask; dry nitrogen was blown into the three-necked flask for 1 h, so as to ensure that there is a dry and oxygen-free environment in the three-necked flask; 6 g of the ferrous chloride tetrahydrate powder was added into the dry aramid material solution and stirred at the speed of 400 r/min for 3 h, so as to cause the ferrous chloride tetrahydrate to be fully dissolved in a dry aramid material solution, and then allowed to stand for 30 h, so as to undergo the complex reaction between the ferrous chloride molecules and the aramid molecules; chemical crosslinking was performed between the ferrous chloride molecules and the aramid molecules, and the blocky complex precipitate 1 was formed after reaction; and the aramid aerogel was obtained finally.

### Performance Test:

A BET test method was used to test the specific surface area and average pore diameter of the aramid aerogel obtained in Embodiments 1-24 (an instrument was a specific surface and pore diameter analyzer, supplier: Hangzhou Neoline Technology Co., LTD, specification and model: JW-BK-400).

A drainage method was used to measure the density of the aramid aerogel prepared in the embodiments and comparative embodiments.

Test results of the specific surface area and average pore diameter of the aramid aerogel obtained in Embodiment 1 were shown in Table 1.

TABLE 1

| | | | |
|---|---|---|---|
| Specific | BET single-point (P/P0 = 0.2) | 429.735 | (m²/g) |
| surface | specific surface area: | | |
| area | BET multipoint specific surface area: | 634.092 | (m²/g) |
| | BJH adsorption cumulative | 1034.593 | (m²/g) |
| | pore internal surface area | | |
| | (within a range of a pore diameter being | | |
| | 1.70-300.00(nm)): | | |
| | BJH desorption cumulative | 964.704 | (m²/g) |
| | pore internal surface area | | |
| | (within a range of a pore diameter being | | |
| | 1.70-300.00(nm)): | | |
| Pore | Single-point adsorption total pore volume: | 0.965 | (cm³/g) |
| volume | BJH adsorption cumulative | | |
| | total pore volume (within a | 1.243 | (cm³/g) |
| | range of a pore diameter | | |
| | being 1.70-300.00(nm)): | | |
| | BJH desorption cumulative | 1.204 | (cm³/g) |
| | total pore volume (within a | | |
| | range of a pore diameter being | | |
| | 1.70-300.00(nm)): | | |
| Pore | Adsorption average pore diameter: | 6.088 | (nm) |
| diameter | BJH adsorption average pore diameter: | 4.806 | (nm) |
| | BJH desorption average pore diameter: | 4.992 | (nm) |

Data of the porosity, specific surface area, density, average pore diameter of pores, and pore volume of the aramid aerogel obtained in part of the above embodiments are listed in Table 2.

TABLE 2

| | | | | Average | |
|---|---|---|---|---|---|
| | | Specific | | pore | |
| Embodiment/ | | surface | | diameter | Pore |
| Comparative | Porosity/ | area/ | Density/ | of pores/ | volume/ |
| embodiment | % | m²/g | mmg/cm³ | nm | cm³/g |
| Embodiment 1 | 99 | 634 | 120 | 6.088 | 0.965 |
| Embodiment 8 | 97 | 623 | 135 | 7 | 0.93 |
| Embodiment 9 | 68 | 110 | 220 | 17 | 0.30 |
| Embodiment 13 | 96 | 623 | 147 | 7.5 | 0.85 |
| Embodiment 14 | 95 | 627 | 142 | 7.9 | 0.83 |
| Embodiment 15 | 65 | 80 | 500 | 30 | 0.05 |
| Embodiment 16 | 94 | 610 | 136 | 7.2 | 0.88 |
| Embodiment 17 | 96 | 619 | 140 | 7.6 | 0.84 |
| Embodiment 18 | 94 | 624 | 149 | 7.9 | 0.83 |
| Embodiment 19 | 70 | 85 | 300 | 20 | 0.20 |

It may be seen from the above description that, in the above embodiments of the present disclosure, the following technical effects are realized.

An application range of the aramid aerogel is expanded by owning the aramid aerogel with the above porosity. In addition, the aramid aerogel has good structure and mechanical properties and excellent thermal insulation performance, and in particular, has a very good application prospect in the field of high temperature thermal insulation, and thus suitable for industrial production.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

What is claimed is:

1. An aramid aerogel, wherein the aramid aerogel is a porous material, and the porosity of the aramid aerogel is 65-99%.

2. The aramid aerogel according to claim 1, wherein a specific surface area of the aramid aerogel is 50-1000 m²/g; and/or a pore volume of the aramid aerogel is 0.05-1.5 cm³/g.

3. The aramid aerogel according to claim 1, wherein an average pore diameter of pores of the aramid aerogel is 1-50 nm; and/or the density of the aramid aerogel is 1-500 mg/cm³.

4. A method for preparing the aramid aerogel according to claim 1, comprising:
step S1, in an oxygen-free atmosphere, performing a complex reaction on raw materials comprising aramid slurry and ferrous halide, so as to obtain a complex precipitate;
step S2, performing a gelation reaction on the complex precipitate and a gelation reagent, so as to obtain gel;
step S3, performing solvent displacement treatment on the gel, so as to obtain an aramid precipitate;
step S4, drying the aramid precipitate, so as to obtain the aramid aerogel.

5. The method according to claim 4, wherein in the step S1, a mass ratio of aramid in the aramid slurry to the ferrous halide is 0.032-0.8:1.

6. The method according to claim 5, wherein the aramid in the aramid slurry is any one or more of poly(p-phenylene terephthamide), polymetaphenylene isophthalamide, poly(p-benzamide), and polyphenylsulfone terephthalamide.

7. The method according to claim 4, wherein in the step S1, the temperature of the complex reaction is 5-60° C.; and/or time for the complex reaction is 0.3-33 h.

8. The method according to claim 4, wherein the aramid slurry comprises a first solvent; and the first solvent is any one or more of dimethyl sulfoxide, N, N-dimethylformamide, N,N-dimethylacetamide, N,N-dimethylhexanamide, N-methylpyrrolidone, and triethyl phosphate.

9. The method according to claim 8, wherein the solid content of the aramid slurry is 1-10%, and/or the pH value of the aramid slurry is 2-7.

10. The method according to claim 4, wherein in the step S1, the ferrous halide is a ferrous halide powder or a ferrous halide solution; the ferrous halide is selected from any one or more of ferrous chloride tetrahydrate, anhydrous ferrous chloride, ferrous bromide hydrate, and anhydrous ferrous bromide; and the ferrous halide solution comprises the ferrous halide and a second solvent.

11. The method according to claim 10, wherein the second solvent is any one or more of water, methanol, ethanol, and acetic acid.

12. The method according to claim 10, wherein a mass ratio of the ferrous halide to the second solvent is 10-20:5-10.

13. The method according to claim 4, wherein in the step S2, the temperature of the gelation reaction is 5-60° C.; and/or time for the gelation reaction is 3-30 h.

14. The method according to claim 4, wherein in the step S2, the gelation reagent is selected from any one or more of water, an aqueous solution containing 20 wt. %-50 wt. % of N, N-dimethylacetamide, hydrochloric acid, sulfuric acid, ethanol, ethylene glycol, glycerol, acetone, tetrahydrofuran, chloroform, dichloromethane, glacial acetic acid, and nitric acid.

15. The method according to claim 4, wherein in the step S3, a number of times for solvent displacement treatment is 3-10, and/or time for solvent displacement treatment is 2-4 h/time.

16. The method according to claim 4, wherein in the step S4, drying treatment comprises performing a vacuum freeze-drying process and/or a vacuum drying process on the aramid precipitate; and the vacuum freeze-drying process comprises: holding the aramid precipitate at −40° C. to −20° C. for 4-10 h, then under a vacuum condition, successively holding the aramid precipitate at −20° C. to −10° C. for 4-10 h, at −10° C. to 0° C. for 4-10 h, and at 0° C. to 10° C. for 4-10 h.

17. The method according to claim 16, wherein the vacuum drying process comprises: the aramid precipitate or the aramid precipitate obtained after vacuum drying is held at 100° C. to 150° C. for 6-10 h.

18. The method according to claim 4, further comprising a process of preparing the aramid slurry; and the preparation process comprises:
performing an amidation reaction on raw materials comprising aromatic diacyl chloride, aromatic diamine, and a third solvent, so as to obtain an amidation product;
neutralizing the amidation product by using an alkaline reagent, so as to obtain a neutralized product;
diluting the neutralized product by using a fourth solvent, so as to obtain the aramid slurry; or
dissolving aramid into the fourth solvent, so as to obtain the aramid slurry.

19. The method according to claim 18, wherein a mass ratio of the aromatic diacyl chloride to the third solvent is 10-30:45-135, and/or a mass ratio of the aromatic diamine to the third solvent is 5-15:45-135; and/or the third solvent and the fourth solvent are respectively independently selected from any one or more of dimethyl sulfoxide, N,N-dimethylformamide, N,N-dimethylacetamide, N,N-dimethylhexanamide, N-methylpyrrolidone, and triethyl phosphate.

20. The method according to claim 18, wherein the solid content of the neutralized product is 10-30%, and/or the using amount of the alkaline reagent is 1-5% of a total mass of the amidation product.
